(19) United States
(12) Patent Application Publication
(10) Pub. No.: US 2024/0124136 A1
(43) Pub. Date: Apr. 18, 2024

(54) ROTOR HUB SYSTEM WITH ROTATING PITCH CONTROL ACTUATOR

(71) Applicant: KOREA AEROSPACE RESEARCH INSTITUTE, Daejeon (KR)

(72) Inventor: Tae Joo KIM, Daejeon (KR)

(73) Assignee: KOREA AEROSPACE RESEARCH INSTITUTE, Daejeon (KR)

(21) Appl. No.: 18/486,339

(22) Filed: Oct. 13, 2023

(30) Foreign Application Priority Data
Oct. 18, 2022 (KR) 10-2022-0133978

(51) Int. Cl. B64C 27/39; B64C 27/78

(52) U.S. Cl. CPC B64C 27/39; B64C 27/78

(57) ABSTRACT

A rotor hub system includes a rotor rotation axis, a flap hinge connected to the rotor rotation axis and enabling flapping motion of a rotor blade, a lead-lag hinge connected to the flap hinge and enabling lead-lag motion of the rotor blade, a first hub to which one end of the rotor blade is fixed, a rotating pitch control actuator connected to the first hub and rotating the first hub to enable pitching motion of the rotor blade, and a second hub equipped with the rotating pitch control actuator and hinged to the lead-lag hinge.

### CROSS-REFERENCE TO RELATED APPLICATION

This application claims priority under 35 U.S.C. § 119 to Korean Patent Application No. 10-2022-0133978, filed in the Korean Intellectual Property Office on Oct. 18, 2022, the entire contents of which are hereby incorporated by reference.

### TECHNICAL FIELD

The present disclosure relates to a rotor hub system, and more specifically, to a rotor hub system applied with a rotating control actuator.

### BACKGROUND

Typically, the rotor hub system used in helicopters, etc. refers to the central part of the rotor where the rotor blades are connected to the drive shaft, and is equipped with a mechanism that controls the drive shaft and blade angle, a hinge that allows the rotor to make separate angular movements with respect to the drive shaft, etc.

As shown in FIG. 1, this rotor hub system allows three rotation movements, which are pitch rotation, flap rotation, and lead-lag rotation, and according to the method of implementing this movement, the related rotor hub systems can be broadly divided into see-saw type (FIG. 1A), fully articulated type (FIG. 1B), hingeless type (FIG. 1C), and bearingless type (FIG. 1D).

For reference, FIG. 2 is a schematic diagram showing three rotational movements of the rotor blade by the rotor hub system. In FIG. 2, reference numerals 100, 200, 300, and 400 denote the flap hinge, the lead-lag hinge, the pitch hinge, and the rotor rotation axis, respectively, and reference numerals R1, R2, and R3 denote the flapping motion, the lead-lag motion, and the pitching movement, respectively.

However, in the related rotor hub system, the pitch rotation movement is implemented through the movement of a swashplate (not shown in FIG. 2), that is, a stationary swashplate (non-rotating area).

As is known, the swashplate is a key part of the helicopter rotor head used to transmit the pilot's control inputs to the rotating blades, and is formed of a pair of upper and lower (or inner and outer) swashplates. Here, the upper swashplate is a rotating part, and the lower swashplate is a stationary part. A ball bearing is located between the upper and lower swashplates to allow independent movement therebetween.

However, since the related rotor hub system uses the swashplates to implement pitch rotation movement, it has a complex structure and uses many bearing parts, resulting in a problem that maintenance and parts replacement are frequent, and vibration and noise are increased.
[Prior Art]: WO2009/004705 (Publication date: Jan. 8, 2009)

### SUMMARY

In order to solve the problems in the related art as described above, an object of the present disclosure is to provide a rotor hub system that has a simple structure and can actively reduce vibration and noise generated by the blades by applying a rotating pitch control actuator without the swashplates.

In order to achieve the object described above, the rotor hub system according to an embodiment of the present disclosure may include a rotor rotation axis, a flap hinge connected to the rotor rotation axis and enabling flapping motion of a rotor blade, a lead-lag hinge connected to the flap hinge and enabling lead-lag motion of the rotor blade, a first hub to which one end of the rotor blade is fixed, a rotating pitch control actuator connected to the first hub and rotating the first hub to enable pitching motion of the rotor blade, and a second hub equipped with the rotating pitch control actuator and hinged to the lead-lag hinge.

Additionally, a thrust bearing may be located between the first hub and the second hub.

Additionally, the rotating pitch control actuator may be mounted inside the second hub.

Additionally, the one end of the rotor blade may be fixed to the first hub by a blade pin.

The rotor hub system according to the embodiments of the present disclosure having the configuration described above has the following effects.

Unlike the related method of controlling the pitching movement of the rotor blades in the non-rotating area through the swashplates, the rotor hub system of the embodiments uses the rotating pitch control actuator to directly control the pitching movement of the rotor blades in the rotation area, thereby eliminating the swashplate parts that are complex structure and contain many bearing parts and thus require frequent maintenance and replacement of parts.

In addition, the rotating pitch control actuator is mounted inside the second hub, and the thrust bearing is located between the first hub and the second hub, such that, of the loads generated from the rotor blades, only the pitching moment is transmitted to the rotating pitch control actuator, and the loads that have a significant structural impact on the rotor, such as the flap moment, the lag moment, and the centrifugal load, are not transmitted to the rotating pitch control actuator.

Meanwhile, it goes without saying that although not explicitly stated, the present disclosure includes other effects that can be expected from the configuration described above.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1A to 1D shows examples of related rotor hub systems;

FIG. 2 is a schematic diagram showing three types of rotational movements of a related rotor hub system; and

FIG. 3 is a side cross-sectional schematic diagram showing the main configuration of a rotor hub system according to an embodiment of the present disclosure.

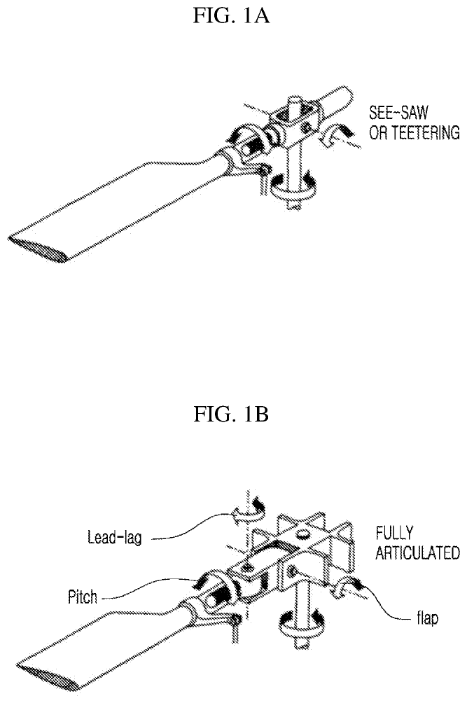

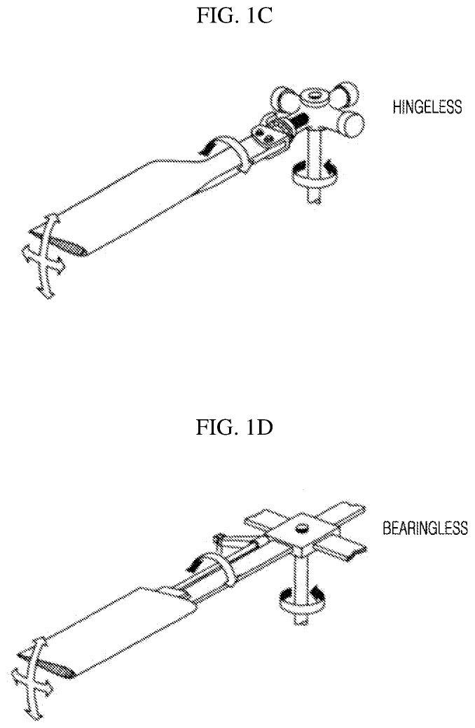

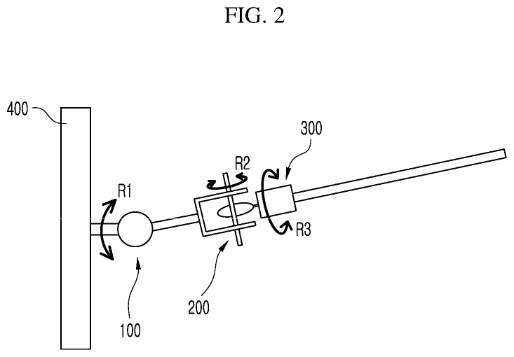

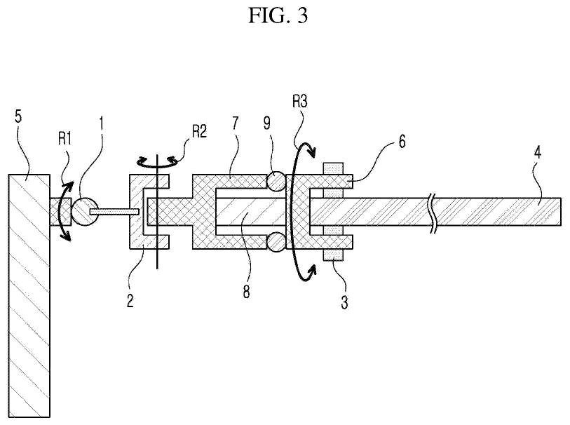

### DETAILED DESCRIPTION

Hereinafter, preferred embodiments of the present disclosure will be described in detail with reference to the accompanying drawings, which will be readily apparent to those skilled in the art to which the present disclosure pertains. However, the description proposed herein is just a preferable example for the purpose of illustrations only, not intended to limit the scope of the disclosure, so it should be understood that other equivalents and modifications could be made thereto without departing from the scope of the disclosure. Meanwhile, the structures of the flap hinge and lead-lag hinge related to the flapping motion and the lead-lag motion of the rotor blade are already known and are irrelevant to the gist of the present disclosure, so the description thereof is omitted so as not to obscure the point of the present disclosure.

FIG. 3 is a schematic diagram showing the main configuration of a rotor hub system according to an embodiment of the present disclosure.

Referring to FIG. 3, the rotor hub system according to an embodiment of the present disclosure includes a rotor rotation axis 5, a flap hinge 1 connected to the rotor rotation axis 5 and enabling flapping motion R1 of a rotor blade 4, and a lead-lag hinge 2 connected to the flap hinge 1 and enabling lead-lag motion R2 of the rotor blade 4.

In particular, the rotor hub system of the present disclosure further includes a first hub 6, a rotating pitch control actuator 8, and a second hub 7.

One end of the rotor blade 4 is fixed to the first hub 6. The one end of the rotor blade 4 may be fixed to the first hub 6 with a blade pin 3.

The rotating pitch control actuator (rotary pitch control actuator) 8 is directly connected to the first hub 6, and rotates the first hub 6, thereby allowing the rotor blade 4 to make pitching motion R3. By way of example, the rotating pitch control actuator 8 may be an electric actuator using a motor.

Through this, unlike the related method of controlling the pitching movement of the rotor blades in the non-rotating area through the swashplates, the rotor hub system of the present disclosure directly controls the pitching movement of the rotor blades in the rotation area, thereby eliminating the swashplate parts that are complex structure and contain many bearing parts and thus require frequent maintenance and replacement of parts.

Additionally, by applying technologies such as higher harmonic control, it is possible to actively reduce vibration and noise generated from the rotor blades.

Meanwhile, the rotating pitch control actuator 8 is mounted on the second hub 7, and the second hub 7 is hinged to the lead-lag hinge 2. For example, the rotating pitch control actuator 8 may be mounted inside the second hub 7.

In addition, a thrust bearing 9 is located between the first hub 6 and the second hub 7. That is, the first hub 6 is connected to the second hub 7 via the thrust bearing 9. For reference, as is widely known, a thrust bearing refers to a bearing in which a load acts in an axial direction parallel toward the rotation axis. Therefore, of the loads generated from the rotor blades, the centrifugal force, the flap moment, and the lead-lag moment are transmitted to the second hub 7 through the thrust bearing, and the pitching moment is not transmitted to the second hub 7 due to the thrust bearing 9, but is transmitted only to the rotating pitch control actuator 8.

That is, of the loads generated from the rotor blades, only the pitching moment is transmitted to the rotating pitch control actuator 8, and the loads that have a significant structural impact on the rotor, such as the flap moment, the lag moment, and the centrifugal load, are not transmitted to the rotating pitch control actuator 8.

As described above, in the present embodiment, the flap hinge 1 and the lead-lag hinge 2 are located at the rear side (left side based on FIG. 3) of the rotating pitch control actuator 8. Therefore, even when the flapping motion or the lead-lag motion occurs, the rotating pitch control actuator 8 can completely implement the desired pitching movement on the rotor blade 4.

Meanwhile, in the present embodiment, the flap hinge and the lead-lag hinge are illustrated as the “mechanical hinges”, but aspects are not limited thereto, and it is needless to say that it is also applicable to hingeless types that implement the functions of these flap hinges and lead-lag hinges as the “physical hinges”.

Although the present disclosure has been described in connection with some examples herein, the present disclosure should not be limited to those examples only, and various other changes and modifications made by those skilled in the art from the basic concept of the disclosure are also within the scope of the claims appended herein.

1. A rotor hub system, comprising:
a rotor rotation axis;
a flap hinge connected to the rotor rotation axis and enabling flapping motion of a rotor blade;
a lead-lag hinge connected to the flap hinge and enabling lead-lag motion of the rotor blade;
a first hub to which one end of the rotor blade is fixed;
a rotating pitch control actuator connected to the first hub and rotating the first hub to enable pitching motion of the rotor blade; and
a second hub equipped with the rotating pitch control actuator and hinged to the lead-lag hinge.

2. The rotor hub system according to claim 1, wherein a thrust bearing is located between the first hub and the second hub.

3. The rotor hub system according to claim 2, wherein the rotating pitch control actuator is mounted inside the second hub.

4. The rotor hub system according to claim 3, wherein the one end of the rotor blade is fixed to the first hub by a blade pin.
